(19) United States
(12) Patent Application Publication
(10) Pub. No.: US 2023/0393882 A1
(43) Pub. Date: Dec. 7, 2023

(54) MANAGEMENT OF VIRTUAL MACHINE SHUTDOWNS IN A COMPUTING ENVIRONMENT BASED ON RESOURCE LOCKS

(71) Applicant: VMware, Inc., Palo Alto, CA (US)

(72) Inventors: Avinash Nagalapur Jambana GOUD, Santa Clara, CA (US); Aniket Avinash Sakhardande, Sunnyvale, CA (US); Alkesh Shah, Palo Alto, CA (US); Brian Masao OKI, San Jose, CA (US); Vasantha Kumari Tammana, San Jose, CA (US)

(21) Appl. No.: 18/325,839

(22) Filed: May 30, 2023

Related U.S. Application Data
(60) Provisional application No. 63/349,334, filed on Jun. 6, 2022.

(51) Int. Cl. G06F 9/455

(52) U.S. Cl. CPC G06F 9/45558; G06F 2009/45575; G06F 2009/45587

(57) ABSTRACT

Described herein are systems, methods, and software to manage virtual machine shutdowns in a computing environment. In one example, a management service identifies a virtual machine file in a file system associated with a first virtual machine and one or more additional virtual machines and identifies a lock on the virtual machine file by the first virtual machine. The management service further stops execution of the one or more additional virtual machines in response to identifying the lock.

### RELATED APPLICATIONS

This application is related to and claims priority to U.S. Provisional Patent Application No. 63/349,334, entitled “MANAGEMENT OF VIRTUAL MACHINE SHUTDOWNS IN A COMPUTING ENVIRONMENT BASED ON RESOURCE LOCKS,” filed on Jun. 6, 2022, and which is hereby incorporated by reference in its entirety.

### BACKGROUND

In computing environments, host computing systems (hosts) support a platform for the execution of virtual machines to use the physical resources of the computing environments more efficiently. Hosts can include a hypervisor that abstracts the physical components of the host and provides abstracted hardware to the executing virtual machine, wherein the virtual machine may include its own operating system and software that uses the abstracted hardware.

In some examples, the virtual machines of the computing environment can share a file system that provides required virtual machine files to support the execution of each virtual machine. The virtual machine files can include virtual disk files, such as virtual machine disks (VMDKs), virtual hard disks (VHDs), or some other virtual disk files, and can further include virtual machine configuration files (VMXs) that provide resource requirements for each virtual machine (processing resources, virtual disks, networking, and the like). The virtual disks are mounted to the virtual machine and can include the operating system for the virtual machine, software for the virtual machine, databases, user data, or some other data for the virtual machine. The virtual disks can be stored on a single host with an executing virtual machine or can be distributed across multiple hosts in a computing environment as part of a distributed file system.

In some examples, multiple virtual machines can request access to the same file in the file system at the same time. This can cause conflicts when a first virtual machine attempts to write to the file, while a second virtual machine attempts to access the same file. While files can be locked in a file system, additional computing resource overhead can be used by the processes attempting to access a file locked by another process.

### SUMMARY

The technology described herein manages virtual machine shutdowns in a computing environment based on resource locks. In one implementation, a method includes identifying a virtual machine file in a file system associated with a first virtual machine and one or more additional virtual machines. The method further includes identifying a lock on the virtual machine file by the first virtual machine and, in response to identifying the lock, stopping execution of the one or more additional virtual machines.

In one implementation, a method includes identifying a prioritization of a first virtual machine over a second virtual machine, wherein the second virtual machine is executing on a first host in a computing environment. The method further provides stopping the execution of the second virtual machine, allocating resources of the second virtual machine on the host to the first virtual machine, and initiating the first virtual machine on the first host with the resources. In some examples, the resources can comprise memory resources, processing resources, or networking resources.

### BRIEF DESCRIPTION OF THE DRAWINGS

FIG. 1 illustrates a computing environment to manage virtual machine shutdowns according to an implementation.

FIG. 2 illustrates a method of managing virtual machine shutdowns in a computing environment according to an implementation.

FIG. 3 illustrates an operational scenario of shutting down a virtual machine in a computing environment according to an implementation.

FIG. 4 illustrates an operational scenario of managing resource availability for virtual machines according to an implementation.

FIG. 5 illustrates a method of managing resource availability for virtual machines in a computing environment according to an implementation.

FIG. 6 illustrates a computing system to manage virtual machine shutdowns and resource availability in a computing environment according to an implementation.

### DETAILED DESCRIPTION

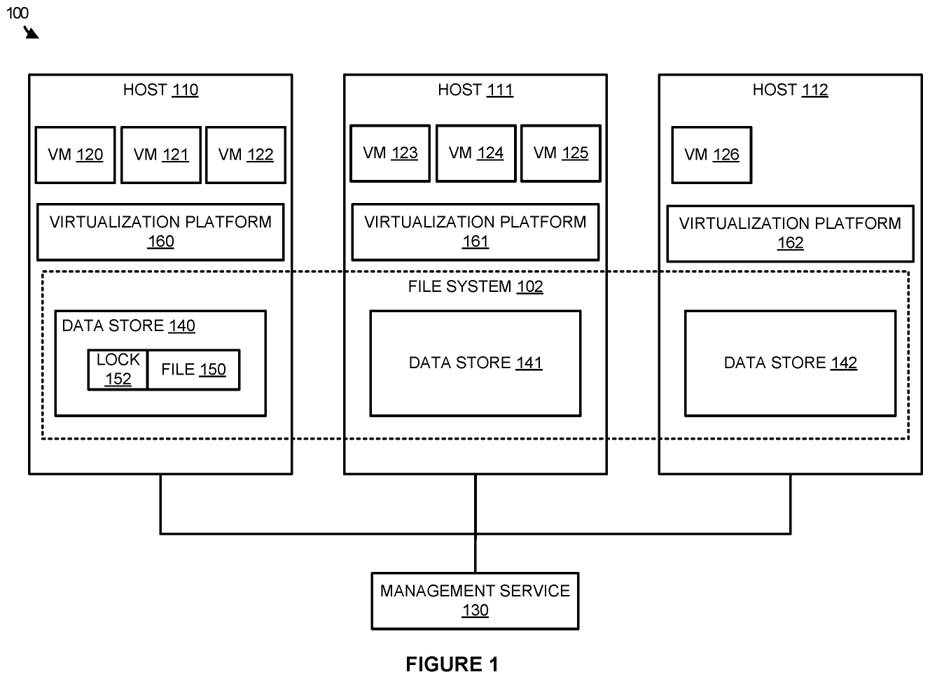

FIG. 1 illustrates a computing environment 100 to manage virtual machine shutdowns according to an implementation. Computing environment 100 includes hosts 110-112 and management service 130. Hosts 110-112 include virtual machines (VMs) 120-126, virtualization platforms 160-162, and file system 102. File system 102 comprises a distributed file system that includes data stores 140-142, wherein data store 140 includes file 150 with lock 152. Although demonstrated as separate from hosts 110-112, management service 130 may execute wholly or partially on hosts 110-112. Management service 130 and hosts 110-112 can each include at least memory and one or more processing systems capable of executing program instructions from the memory.

In computing environment 100, hosts 110-112 are deployed to provide a platform for virtual machines 120-126. Virtual machines 120-126 include virtualization platforms 160-162, which is representative of a hypervisor that can provide resources to each virtual machine of virtual machines 120-126. The resources can include processing resources, memory resources, networking resources, storage, or some other resources. The physical resources of the host are abstracted by virtualization platforms and provided to various virtual machines, which permits different resources to be allocated to different virtual machines. For example, a first virtual machine can be allocated a first amount of memory, while a second virtual machine can be allocated a second amount of memory from the host.

In some implementations, one or more virtual disk files can be mounted to each virtual machine, wherein the virtual disk files can include the operating system and applications for the virtual machine, a database, or other data structure for processing by the virtual machine, user data, or some other data for the virtual machine. The virtual disk files can comprise virtual machine disks (VMDKs), virtual hard disks (VHDs). Other virtual machine files required for the operation of a virtual machine can include a virtual machine configuration file (VMX), wherein the virtual machine configuration file includes hardware resource definitions for the virtual machine, including disk requirements, processing requirements, memory requirements, networking requirements, or some other configuration information for the virtual machine. In some examples, a virtual machine file can be requested by multiple virtual machines in a computing environment. For example, virtual machine 120 and virtual machine 123 may each require use of file 150 in data store 140. Here, in addition to the virtual machine file itself, file 150 is associated with lock 152 that represents metadata and a current owner of file 150. Lock 152 may include bits that provide an identifier for the virtual machine with a current lock on file 150. Thus, while both virtual machines may require file 150, the lock can identify the requesting virtual machine and can prevent access to any requesting virtual machine not identified in lock 152.

In some examples, when file 150 is first requested to be made available to a virtual machine, such as virtual machine 120, the identifier for virtual machine 120 is included in lock 152. File system 102 may then maintain this lock 152 so long as virtual machine 120 is accessing data in file 150. In at least one implementation, file system 120 maintains a timeout associated with file 150, wherein the timeout is used to identify when to remove lock 152. Lock 152 can be removed by express indication or request to transfer the lock to another virtual machine or can be removed after the expiration of the timeout period. For example, virtual machine 120 may not generate a request during a timeout period for file 150, wherein the timeout period can be defined by an administrator associated with file system 102 or file 150. After the expiration of the timeout, another virtual machine, such as virtual machine 123 can access and lock file 150.

To conserve resources in computing environment 100, management service 130 is provided that can identify when multiple virtual machines request access to the same lockable file. Management service 130 may include at least one data structure that indicates the file requirements for each of the virtual machines, may request file requirement information for the virtual machines from the hosts, or may request file requirements from some other source. Based on the file requirements for the different virtual machines, management service 130 can identify when multiple virtual machines require access to the same file and can further identify when the file is associated with a lock. In some examples, at least a portion of the virtual machine files available in file system 102 can require locks to prevent writes that may interrupt the operations of another virtual machine. Thus, when a first virtual machine has a lock on file 150, other virtual machines are incapable of accessing the data from file 150, preventing proper operations associated with the other virtual machines. Management service 130 identifies when multiple virtual machines require access to the same locked file and stops the execution of virtual machines without the lock on the file. For example, when virtual machine 120 is identified in lock 152, any other virtual machine in computing environment that has a requirement of accessing file 150 can be stopped or shutdown to limit the resource usage of the virtual machine.

In some implementations, in addition to or in place of implementing the operations for stopping virtual machines that don't have a lock on a required file, management service 130 identifies when a first virtual machine should replace a second virtual machine. As an example, a client, external or internal to computing environment 100, can request to deploy a first virtual machine. In response to the request, management service 130 can determine which virtual machine in the computing environment to stop and reallocate the resources to the first virtual machine. The virtual machine selected to be stopped can be indicated in the request for the first virtual machine, can be selected based on the priority associated with the virtual machine, can be based on the similarity in resource requirements, can be based on the headroom in the hosts, or can be based on any other factor, including combinations thereof.

Once the virtual machine is selected to be replaced, the selected virtual machine can be stopped, the resources of the stopped virtual machine can be allocated to the first virtual machine, and the first virtual machine can be started. As an example, management service 130 can identify a new virtual machine to be deployed in computing environment 100. Once identified, management service 130 can stop execution of a virtual machine based on priority, allocate resources from the stopped virtual machine to the first virtual machine, and initiate the first virtual machine with the resources of the identified virtual machine. The resources can include processing resources, memory resources, networking resources, and the like.

For example, if virtual machine 124 were identified to be stopped for new virtual machine 125, virtual machine 124 can be stopped and the resources allocated to virtual machine 125. The resources can include processing, memory, networking, or some other resource. Virtual machine can be identified based on a preference of the client initiating virtual machine 125, based on the priority value associated with the virtual machines, based on the virtual machine with the most similar resource requirements to virtual machine 125, or some combination thereof. Once identified, virtual machine 124 is stopped, the resources are allocated to virtual machine 125, and virtual machine 125 is initiated. Virtual machine 125 can use different virtual disk files than virtual machine 124, but can be provided with the same abstracted resources.

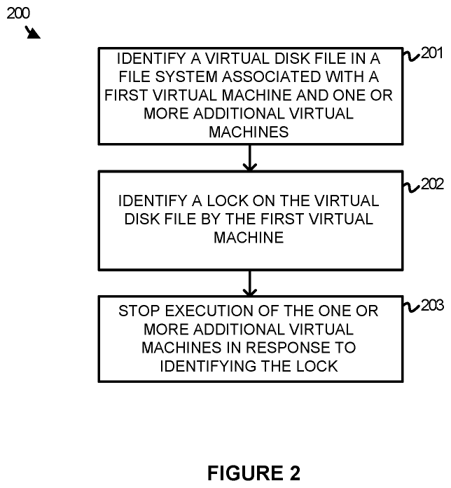

FIG. 2 illustrates a method 200 of managing virtual machine shutdowns in a computing environment according to an implementation. The steps of method 200 are referenced parenthetically in the paragraphs that follow with reference to systems and elements of computing environment 100 of FIG. 1. Method 200 can be implemented by management service 130, wherein management service 130 may reside on one or more separate computers or may execute at least partially on hosts 110-112.

Method 200 includes identifying (201) a virtual machine file in a file system associated with a first virtual machine and one or more additional virtual machines. As described previously, virtual machines 120-126 are deployed in a computing environment on hosts 110-112. Each virtual machine of virtual machines 120-126 is provided resources, including computing resources by virtualization platforms 160-162, and files (virtual machine files) supported by file system 102. The computing resources include processing resources, memory resources, networking resources, and the like that comprise abstracted components from the physical host. In some implementations, multiple virtual machines can require access to the same file in file system 102. In examples where the file is read-only or otherwise unmodifiable by the virtual machines, the virtual machines can access the same file without issue. In other examples, the file is associated with lock metadata in file system 102 that can limit the access to the virtual machine (or machines in some examples) to access the file. For example, when virtual machine 120 is initiated and requires the use of file 150, an identifier for virtual machine 120 can be included in lock 152 for file 150. In some example, multiple virtual machines are initiated that can both require or be directed to use the same lockable file 150. However, any virtual machine that is not identified in lock 152 can be blocked or prevented from accessing or mounting the file.

Management service 130 monitors the file requirements associated with each virtual machines and determines when multiple virtual machines share the same lockable file. Management service 130 can maintain at least one data structure that indicates the files associated with each of the virtual machines, can be provided with file requirements from each of the host, can be provided from virtual machine manager for the computing environment, or can identify the files associated with each virtual machine in any other manner. When management service 130 determines that the first virtual machine and the one or more additional virtual machines are each associated with the file (or require access or mount of the file), the method further provides identifying (202) a lock on the virtual machine file by the first virtual file. In some implementations, management service 130 performs a check on the metadata associated with the file to determine the current ownership of the file. For file 150, management service 130 may check the metadata portion associated with file 150 to determine the current lock owner associated with the file, wherein lock 152 can include an identifier for the current virtual machine owner. In response to determining that the first virtual machine is identified in the lock, the method further provides stopping (203) execution of the one or more additional virtual machines.

As an example, virtual machine 120 can be identified in lock 152 for file 150, while virtual machines 124-125 are also associated with or require the use of file 150. When management service 130 identifies the lock associate with file 150, management service 130 may initiate an operation on host 111 to stop the execution of virtual machines 124-125. This can include communicating with virtualization platform 161 to stop the execution of virtual machines 124-125. Once stopped, the resources of host 111 can be allocated to other virtual machines.

In some implementations, the lock on a file can be subject to a timeout period, wherein the timeout can permit other virtual machines to access a file that has not been active for a period. The period can be defined for all of file system 102, can be defined in association with the file, or can be defined in some other manner. In response to a timeout associated with the file (e.g., the virtual machine with the lock not requesting data associated with file), the lock can be released permitting another virtual machine to be allocated the lock for the file.

In some examples, a direct request from a management client may also permit the lock to be released on a file. As an example, an administrator of computing environment 100 can generate a request that permits a first virtual machine to assume access of a file over another virtual machine in computing environment 100. In response to the request, management service 130 can stop the virtual machine associated with the current lock on the file, remove the current lock on the file, and allocate the lock on the file to the first virtual machine. Once allocated, the first virtual machine can be initiated.

In some implementations, management service 130 can implement a delay in stopping virtual machines that do not have a lock on a required file. For example, while management service 130 can identify that virtual machine 120 and virtual machine 123 each require file 150 and the file is locked to virtual machine 120, management service 130 can be configured to delay the stoppage of virtual machine 123 if the overlapping requirement for file 150 is temporary. Thus, if virtual machine 120 released file 150 within the delay period, virtual machine 123 may become the owner or lock the file after the release. However, if the lock by virtual machine 120 extends longer than the delay period, then management service 130 can stop the execution of virtual machine 123.

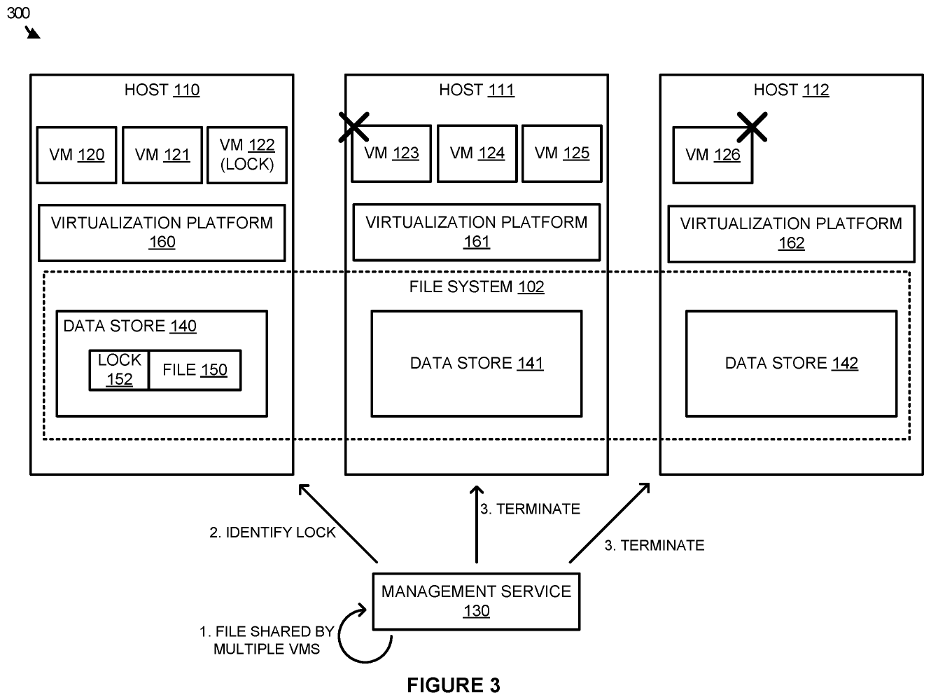

FIG. 3 illustrates an operational scenario 300 of shutting down a virtual machine in a computing environment according to an implementation. Operational scenario 300 includes systems and elements from computing environment 100 of FIG. 1. Although demonstrated with three hosts and seven virtual machines, any number of hosts and virtual machines can be deployed in a computing environment.

In operational scenario 300, management service 130 monitors the virtual machines in the computing environment to identify when two or more virtual machines require the use of the same lockable file. Management service 130 can maintain information in one or more data structures about the deployed virtual machines in the computing environment or can obtain information from one or more other control systems (including hosts) to identify the file requirements for each of the virtual machines. Management service 130 may also identify the files that include locks that can be assigned to virtual machines, wherein files that do not include locks can be ignored by management service 130.

Here, management service 130 identifies lock 152 that indicates virtual machine 122 as the current owner of file 150 at step 1 and identifies virtual machines 123 and 126 are also associated with or require the use of file 150 at step 2. In response to determining that file 150 is shared by multiple virtual machines, management service 130 terminates or stops the execution of virtual machines 123 and 126. In some implementations, management service 130 communicates with virtualization platforms 161-162 to stop the virtual machines. After stopping the virtual machines, hosts 111-112 can allocate the resources of virtual machines 123 and 126 to other virtual machines waiting to be initiated.

In some examples, management service 130 may employ a waiting period prior to stopping the execution of virtual machines. Management service 130 can initiate the waiting period in response to identifying that a file is associated with or required by multiple virtual machines. If, at the expiration of the waiting period, the same virtual machines continue to execute and rely on the same file, then the one or more virtual machines that are not identified in the lock metadata can be stopped. However, if the virtual machines that are not identified in the lock metadata are no longer executing or have changed the file requirements, then no action can be taken by management service 130. As an example, when management service 130 identifies that virtual machine 122 is the current owner of file 150, but file 150 is also associated with virtual machines 123 and 126, management service 130 can initiate a waiting period prior to stopping the execution of virtual machines 123 and 126. After the expiration of the waiting period, management service 130 can act by stopping virtual machines 123-126 if they have not already stopped execution or changed configuration requirements that no longer include file 150.

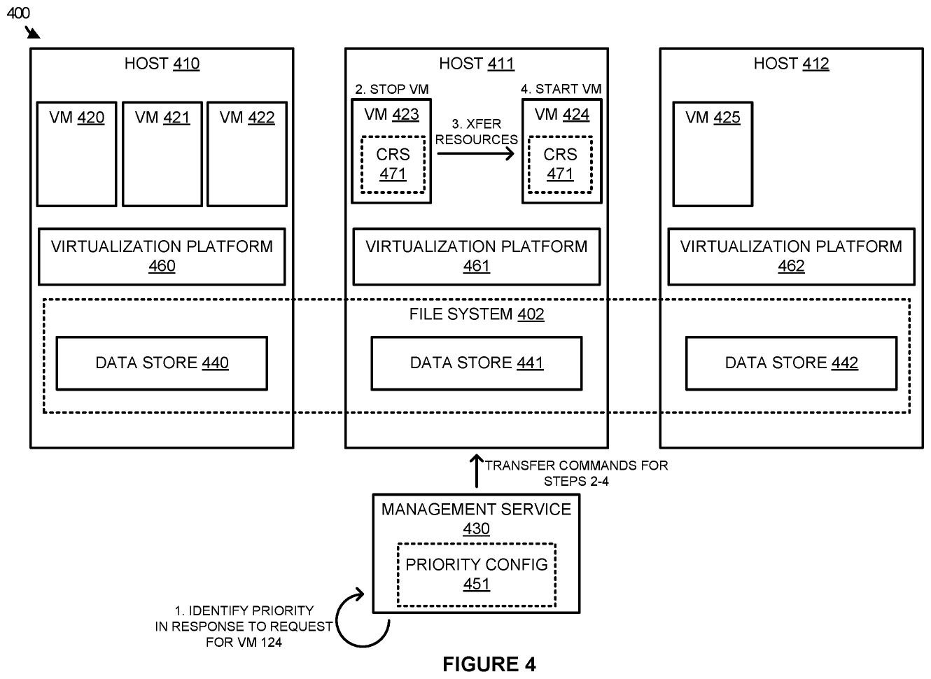

FIG. 4 illustrates an operational scenario 400 of managing resource availability for virtual machines according to an implementation. Operational scenario 400 includes hosts 410-412 and management service 430. Hosts 410-412 include virtual machines 420-425, virtualization platforms 460-462, and file system 402 that includes data stores 440-442. File system 402 can include various files, wherein at least a portion of the files can include virtual disk files that can support operating systems, applications, databases, or some other virtual disk file. The files can also include virtual machine configuration files in some examples. Management service 430 further includes priority configuration 451 that indicates priorities of virtual machines in relation to other virtual machines. Although demonstrated as separate from hosts 410-412, management service 430 can be implemented wholly or partially on hosts 410-412.

In addition to or in place of the operations described in FIGS. 1-3 to stop virtual machines that are associated with a file that is locked by another virtual machine, management service 430 can be used to allocate resources to virtual machines based on priorities associated with the virtual machines. As depicted in operational scenario 400, in response to a request to initiate virtual machine 124, management service 430 identifies a prioritization of virtual machines defined by priority configuration 451 at step 1. Priority configuration 451 may include one or more data structures or rules defined by an administrator that indicates the priority of virtual machines in relation to each other. Priority configuration 451 may also include an express indication from an administrator to replace or prioritize a first virtual machine (e.g., virtual machine 424) over a second virtual machine (e.g., virtual machine 423).

In some implementations, the identification of priority for virtual machines may occur in response to determining that resource usage associated with hosts 410-412 satisfy resource usage criteria. The criteria may include processing system resource usage, memory usage, networking usage, or some other usage criteria. For example, when a request is generated for virtual machine 424 to be deployed, management service 430 may determine that processing resources in the computing environment are not available to support the execution of virtual machine 424.

Here, in response to identifying virtual machine 424 to be added to the computing environment, management service 430 determines that virtual machine 423 should be replaced. The client that requests the deployment of virtual machine 424 can directly request that virtual machine be selected for replacement, can be selected based on the priority of virtual machine 423 in relation to virtual machine 424, can be selected based on resource requirements for virtual machine 424 in relation to virtual machine 423, or can be selected based on a combination of the resource requirements and priorities between virtual machine 424 and the other virtual machines existing in the computing environment.

Once virtual machine 423 is identified to be stopped, management service 430 initiates an operation to stop virtual machine 423 at step 2. After stopping virtual machine 423, management service further triggers a transfer of resources from virtual machine 423 to virtual machine 424 at step 3 and initiates the execution of virtual machine 424 using the resources of virtual machine 423 at step 4. Demonstrated in FIG. 4 using computing system resources (CRS) 471. The computing resources may include processing resources, memory resources, networking resources, and the like.

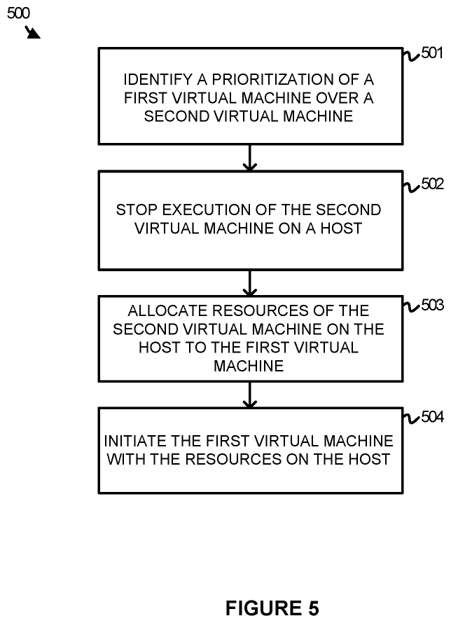

FIG. 5 illustrates a method 500 of managing resource availability for virtual machines in a computing environment according to an implementation. The steps of method 500 are referenced parenthetically in the paragraphs that follow. Method 500 can be implemented by a management service, such as management service 430 from FIG. 4.

Method 500 includes identifying a prioritization (501) of a first virtual machine over a second virtual machine in a computing environment. The prioritization can be defined by an administrator associated with the computing environment, wherein the prioritization may comprise values associated with the virtual machines in the computing environment. For example, virtual machines with a value of one can be prioritized over virtual machines with a value of two. In some examples, when the first virtual machine is to be deployed, the management service can identify a lower priority virtual machine with resource requirements that match or provide sufficient resources for the first virtual machine. Additionally, the management service can identify the virtual machine with the lowest priority for replacement with the adequate resources.

After the prioritization is identified, method 500 further provides stopping (502) execution of the second virtual machine on a host, (503) allocate resources of the second virtual machine to the first virtual machine, and (504) initiating the first virtual machine with the resources on the host. The resources can include processing resources, memory resources, networking resources, and the like. The first and second virtual machines may use different virtual disks in some examples.

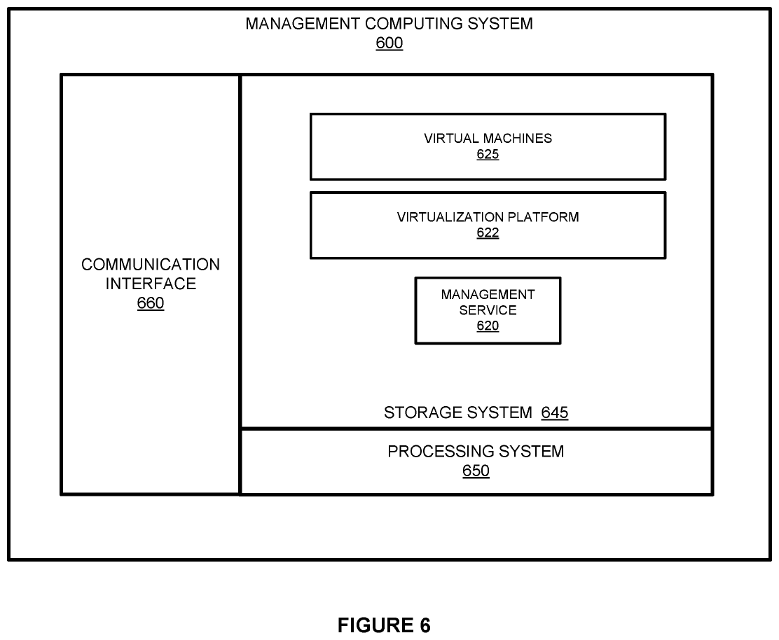

FIG. 6 illustrates a management computing system 600 to manage virtual machine shutdowns and resource availability in a computing environment according to an implementation. Management computing system 600 is representative of any computing system or systems with which the various operational architectures, processes, scenarios, and sequences disclosed herein for management service can be implemented. Management computing system 600 is an example of management service 130 and 430, although other examples may exist. Management computing system 600 includes storage system 645, processing system 650, and communication interface 660. Processing system 650 is operatively linked to communication interface 660 and storage system 645. Communication interface 660 may be communicatively linked to storage system 645 in some implementations. Management computing system 600 may further include other components such as a battery and enclosure that are not shown for clarity.

Communication interface 660 comprises components that communicate over communication links, such as network cards, ports, radio frequency (RF), processing circuitry and software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format—including combinations thereof. Communication interface 660 may be configured to communicate with one or more hosts in a computing environment. Communication interface 660 can also communicate with client systems and other management systems to implement the resource management operations described herein.

Processing system 650 comprises microprocessor and other circuitry that retrieves and executes operating software from storage system 645. Storage system 645 may include volatile and nonvolatile, removable, and non-removable media implemented in any method or technology for storage of information, such as computer readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or some other form of machine-readable program instructions. The operating software of storage system 645 comprises virtual machines 625, virtualization platform 622, and management service 620. The operating software on storage system 645 may further include an operating system, utilities, drivers, network interfaces, applications, or some other type of software. When read and executed by processing system 650 the operating software on storage system 645 directs management computing system 600 to operate as a host described herein in FIG. 1-5.

In at least one implementation virtualization platform 622 directs processing system 650 to support virtual machines 425. Virtualization platform 622 can provide access to abstracted resources, including processing resources, memory resources, networking resources, or other similar resources. Virtual machines 625 can each require one or more virtual disk files that can be attached or mounted via virtualization platform 622, wherein the virtual disk files can reside in a file system located on host computing system 600 and/or one or more additional host computing systems. Virtual machines can also require access to virtual machine configuration files that each include hardware settings including the hard disk, network adapters, memory, CPU or processing resources, ports, power options, and the like.

Here, management service 620 directs processing system 650 to at least identify a virtual machine file in the file system that is associated with a first virtual machine and one or more additional virtual machines. In some implementations, multiple virtual machines can be configured to require the same file, wherein the file can be locked in the file system or associated with a single virtual machine instance. To overcome the issue, management service 620 identifies a lock on the file by the first virtual machine and, in response to identifying the lock, stops execution of the one or more additional virtual machines that are also associated with the file. In some examples, management service 620 can first determine whether the file is associated with a lock and will only implement an action when a lock is associated with the file. Otherwise, management service 620 may take no action, as in the example of read-only files, multiple virtual machines can access the same file.

In some examples, management service 620 can employ delays prior to stopping the execution of the one or more virtual machines. In at least one implementation, management service 620 directs processing system 650 to identify when a first virtual machine and one or more virtual machines are associated with the same file, and the first virtual machine has a lock on the file. In response to identifying that the first virtual machine and the one or more additional files are associated with the same file, management service 620 directs processing system to initiate a monitor or delay period associated with the file to determine whether the one or more additional virtual machines continue to require the locked file, whether the locked file is unlocked by the first virtual machine and assumed by a second virtual machine of the one or more additional virtual machines, whether the one or more additional virtual machines are stopped or have the configuration modified to no longer request the file, or some other modification that eliminates the association of the file with multiple virtual machines. As an example, a first virtual machine may have a lock on a file, while a second virtual machine is also associated with the virtual machine. Once identified by management service 620, management service 620 can set a timer associated with the conflict to determine whether the conflict continues after the expiration of the timer. If the conflict no longer exists, then management service 620 will not take an action on an executing virtual machine. However, if the conflict persists, management service 620 can stop the execution of the second virtual machine without the conflict. Advantageously, when a temporary conflict exists, management service 620 may abstain from taking an action on virtual machines in the computing environment but can act on virtual machines that unnecessarily use computing resources without access to a required file.

In addition to or in place of stopping virtual machines that are requesting a file resource that is locked with another virtual machine, management service 620 can direct processing system 650 to identify a prioritization of a first virtual machine over a second virtual machine. The priority identification can occur when resources are limited on a host such as computing system 600 or a cluster of two or more hosts. For example, when resources are limited on computing system 600 and a new virtual machine is to be deployed, the resources of another virtual machine can be taken and provided to the new virtual machine. The resources can be processing resources, memory resources, networking resources, or other similar resources.

In at least one implementation, virtual machines can be allocated or assigned a priority level that indicates the priority of the virtual machine in relation to other virtual machines. The assigned priority can be numerical, a letter grade, or some other indication of priority in relation to other virtual machines in the computing environment. When a first virtual machine is requested, management service 620 directs processing system to identify a second virtual in the computing environment with a lower priority than the first virtual machine. Management service 620 may identify the lowest priority virtual machine, the virtual machine with the resources that are adequate for the new virtual machine, the virtual machine defined by the client requesting the new virtual machine, or some other definition, or combinations thereof. Once a virtual machine is identified, the virtual machine is stopped, and the resources of the virtual machine are allocated to the new virtual machine. The resources may include processing resources, memory resources, networking resources, and the like. Once allocated to the new virtual machine, the virtual machine can execute using the same resources of the formerly executing virtual machine.

Although demonstrated with virtual machines executing on a computing system with management service 620, virtual machines may execute on hosts separate from management service 620. Computing system 600 may also communicate with one or more other hosts in the computing environment to implement the desired power operations described herein, including stopping virtual machines, allocating resources to different virtual machines, and initiating virtual machines.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
identifying a virtual machine file in a file system associated with a first virtual machine and one or more additional virtual machines;
identifying a lock on the virtual machine file by the first virtual machine; and
in response to identifying the lock, stopping execution of the one or more additional virtual machines.

2. The method of claim 1, wherein the first virtual machine and the one or more additional virtual machines execute on a plurality of hosts.

3. The method of claim 1, wherein identifying the lock on the virtual machine file comprises identifying an identifier for the first virtual machine in metadata portion for the virtual machine file.

4. The method of claim 1, wherein the file system comprises a distributed file system distributed over a plurality of hosts.

5. The method of claim 1, wherein the virtual machine file comprises a virtual machine disk (VMDK), a virtual hard disk (VHD), or a virtual machine configuration file (VMX).

6. The method of claim 1 further comprising:
identifying a prioritization of a second virtual machine over a third virtual machine, wherein the third virtual machine is executing on a host;
stopping execution of the third virtual machine;
allocating resources of the third virtual machine on the host to the second virtual machine; and
initiate the second virtual machine with the resources.

7. The method of claim 6, wherein the resources comprise memory resources, processing resources, or networking resources.

8. The method of claim 6 further comprising:
identifying a resource limit satisfying one or more criteria on the host; and
wherein identifying the prioritization of the second virtual machine over the third virtual machine occurs in response to identifying the resource limit satisfying one or more criteria.

9. A computing apparatus comprising:
a storage system;
a processing system operatively coupled to the storage system; and
program instructions stored on the storage system that, when executed by the processing system, direct the computing apparatus to:
identify a virtual machine file in a file system associated with a first virtual machine and one or more additional virtual machines;
identify a lock on the virtual machine file by the first virtual machine; and
in response to identifying the lock, stop execution of the one or more additional virtual machines.

10. The computing apparatus of claim 9, wherein the first virtual machine and the one or more additional virtual machines execute on a plurality of hosts.

11. The computing apparatus of claim 9, wherein identifying the lock on the virtual machine file comprises identifying an identifier for the first virtual machine in metadata portion for the virtual machine file.

12. The computing apparatus of claim 9, wherein the file system comprises a distributed file system distributed over a plurality of hosts.

13. The computing apparatus of claim 9, wherein the virtual machine file comprises a virtual machine disk (VMDK), a virtual hard disk (VHD), or a virtual machine configuration file (VMX).

14. The computing apparatus of claim 9, wherein the program instructions further direct the computing apparatus to:
identify a prioritization of a second virtual machine over a third virtual machine, wherein the third virtual machine is executing on a host;
stop the execution of the third virtual machine;
allocate resources of the third virtual machine on the host to the second virtual machine; and
initiate the second virtual machine with the resources.

15. The computing apparatus of claim 14, wherein the resources comprise memory resources, processing resources, or networking resources.

16. The computing apparatus of claim 14, wherein the program instructions further direct the computing apparatus to:
identify a resource limit satisfying one or more criteria on the host; and
wherein identifying the prioritization of the second virtual machine over the third virtual machine occurs in response to identifying the resource limit satisfying one or more criteria.

17. A method comprising:
identifying a prioritization of a first virtual machine over a second virtual machine, wherein the second virtual machine is executing on a host;
stopping execution of the second virtual machine;
allocating resources of the second virtual machine on the host to the first virtual machine; and
initiating the first virtual machine with the resources.

18. The method of claim 17, wherein the resources comprise memory resources, processing resources, or networking resources.

19. The method of claim 17 further comprising:
identifying a resource limit satisfying one or more criteria on the host; and
wherein identifying the prioritization of the first virtual machine over the second virtual machine occurs in response to identifying the resource limit satisfying one or more criteria.

20. The method of claim 17, wherein the first virtual machine and the second virtual machine are associated with identical resource requirements.
